(19) United States
(12) Patent Application Publication
(10) Pub. No.: US 2009/0133107 A1
(43) Pub. Date: May 21, 2009

(54) Method and device of enabling a user of an internet application access to protected information

(76) Inventor: Anders Thoursie, Nacka (SE)

Correspondence Address: HARNESS, DICKEY & PIERCE, P.L.C., P.O. BOX 8910, RESTON, VA, 20195, US

(21) Appl. No.: 11/918,873

(22) PCT Filed: Apr. 20, 2005
(86) PCT No.: PCT/SE2005/000567

§ 371 Date: Oct. 19, 2007

(51) Int. Cl. H04L 9/32

(52) U.S. Cl. 726/6

(57) ABSTRACT

A method and a system are disclosed, of enabling a user of an Internet application to access protected information. An idea behind at least one embodiment of the invention is that a user identifier token is created, after a user has been authenticated by way of a logon mechanism of the Internet application. The user identifier token is then associated with the authenticated user and stored at an Internet client of the authenticated user. When protected information is to be made available for a requesting user, the concerned set of protected information is associated with the authenticated user and an information identifier token is created and associated with the protected information. The information identifier token is delivered to the authenticated user via e-mail. When a request is received from a requesting user, it is verified that the request comprises a user identifier token and an information identifier token, that there exists an association between these tokens and the previously authenticated user and the protected information, respectively, and that the requested protected information is associated with the authenticated user. If so, the requesting user is allowed to access the protected information.

### TECHNICAL FIELD OF THE INVENTION

The present invention relates to a method of enabling a user of an Internet application to access protected information. The invention further relates to a system of enabling a user of an Internet application to access protected information.

### BACKGROUND ART

Today, companies deliver a great amount of information to customers and other parties via the Internet. The information may comprise marketing information, or subscribed information in the form of newsletters. To an ever-increasing extent, companies also choose to deliver core business information over the Internet, such as invoices, account statements, insurance statements, salary statements, etc. For this type of information, there are strong requirements that:
the information is sent confidentially, i.e. only the recipient should be allowed to access the information, and that
the distribution of the information is sender controlled, i.e. the sender of the information should be able to alert the recipient when the information is available.
   There are currently available solutions that meet these requirements. One example is to send information through e-mail and to use Public Key Infrastructure, PKI, involving encryption of the information with the public key of a recipient certificate. Such a solution may give a high level of protection. However, it is also costly and rather complicated, both from a sender and from a recipient point of view, e.g. since it requires all recipients to acquire certificates prior to receiving the information.

Another solution is to provide the recipient of the information with a user account and letting the users access information after login. However, it is often conceived as laborious if the logon mechanism should be used merely for the task of reading a message or a document. The logon procedure can be simplified by using a so-called general logon cookie, containing access information to the user account. Typically, a cookie is a file that is stored by a server at the client computer. The file generally contains information pertaining to the client computer or a user that operates the computer.

This use of a general logon cookie has the unwanted effect that anybody in access of the computer with the cookie can access the entire user account at any time. An intruder can then obtain confidential information and may even perform transactions, such as issuing an order, in the name of the user to whom the cookie belongs.

### SUMMARY OF THE INVENTION

An object of the invention is to alleviate the problems of prior art by providing a straightforward and user-friendly way of enabling a user to access protected information.

This object is accomplished by a method of enabling a user of an Internet application access to protected information in accordance with claim 1, and a device for enabling a user of an Internet application access to protected information in accordance with claim 21.

According to a first aspect of the present invention, a method is provided comprising the steps of creating a user identifier token after having authenticated a user by means of a logon mechanism of the Internet application, associating the user identifier token with the authenticated user and storing the user identifier token at an Internet client of the authenticated user, the user identifier token not giving access to said Internet application. Further, the protected information is associated with the authenticated user, an information identifier token is created, the information identifier token not giving access to the Internet application, neither by itself nor in combination with the user identifier token and the information identifier token is associated with the protected information. Moreover, the information identifier token is delivered to the authenticated user via e-mail. Finally, a request is received from a requesting user to access the protected information, which request comprises a user identifier token and an information identifier token, and it is verifying, by means of the associations, that the user identifier token of the request is associated with the authenticated user, that the authenticated user is associated with the requested protected information and that the requested protected information is associated with the information identifier token of the request, wherein the requesting user is allowed to access the protected information.

According to a second aspect of the present invention, a device is provided comprising means for creating a user identifier token after having authenticated the user by means of a logon mechanism of the Internet application, means for associating the user identifier token with the authenticated user and means for delivering the user identifier token to an Internet client of the authenticated user, the user identifier token not giving access to the Internet application. Further, the device comprises means for associating the protected information with the authenticated user, means for creating an information identifier token, the information identifier token not giving access to the Internet application, neither by itself nor in combination with the user identifier token. Moreover, the device comprises means for associating the information identifier token with the protected information, means for delivering the information identifier token to the authenticated user via e-mail and means for receiving a request from a requesting user to access the protected information. Finally, the device comprises means for verifying that said request comprises a user identifier token and an information identifier token, and that the user identifier token of the request is associated with the authenticated user, that the authenticated user is associated with the requested protected information and that the requested protected information is associated with the information identifier token of the request, allowing the requesting user to access the protected information.

A basic idea of the present invention is that a user identifier token is created, after a user has been authenticated by means of a logon mechanism of an Internet application. The user identifier token may for instance be created during a web session in which a user signs up for a service at the company with which the user is an employee, e.g. electronic delivery of monthly salary specification, via a login (involving a user name and a password) to the Internet application supplying the service, wherein the user is authenticated.

The user identifier token is then associated with the authenticated user and stored at an Internet client of the authenticated user. When protected information is to be made available for a requesting user, the concerned set of protected information is associated with the authenticated user and an information identifier token is created and associated with the protected information. The information identifier token is delivered to the authenticated user via e-mail. When a request is received from a requesting user, which not necessarily is the same user as the previously authenticated user, to access the protected information, it is verified that the request comprises a user identifier token and an information identifier token, that there exists an association between these tokens and the previously authenticated user and the protected information, respectively, and that the requested protected information is associated with the authenticated user. If so, the requesting user is allowed to access the protected information.

The user identifier token and the information identifier token are arranged in such a way that they do not give access to the user account of the Internet application, neither by themselves nor in combination.

The method thus provides the authenticated user with two different tokens at two different occasions. Each token is useless in itself and can only be successfully used in combination. For instance, when the monthly salary specification has been created, the information identifier token is delivered to the previously authenticated user via e-mail. A user which requests access to the salary specification needs to be in possession of both tokens to actually access the specification. Further, the information is protected in the sense that only a provider of the information has access to it, which has as an effect that the protected information cannot be accessed by an unauthorized third party. A precondition for receiving the user identifier token is that the user can be authenticated through using a logon mechanism to an Internet application.

The method provides a way of making the protected information available to the (authenticated) users in a user-friendly and convenient way, allowing them to access the information easily and often, without repeatedly having to use the existing logon mechanism. At the same time, the Internet application has a high level of protection. To access the application, users need to use the ordinary logon mechanism.

It should be noted that a secure channel may be set up for transmission of the information. In that case, the integrity of the transmitted information may be ensured. Possibly, cryptographic functions may also be employed to further provide for information integrity. A hash value may be created for the protected information and a requesting user is given access to this hash value on successful verification. Hence, the requesting user is able to check that the protected information has not been modified during transmittal. Further, the protected information may be provided with a digital signature, wherein non-repudiation is ensured. Moreover, the hash value may be encrypted, whereby confidentiality is provided to the hash value.

In an embodiment of the present invention, the information identifier token is a link to certain protected information, and when a requesting user activates the link, i.e. makes a request to access the protected information, the user identifier token stored at the client of the requesting user and the information identifier token is supplied to the provider of the protected information, either by actively sending the two tokens from the requesting user to the provider or having the provider access the two tokens at the user side. The information provider then verifies whether the requesting user may be given access to the protected information, as described in the above. Hence, determination is made whether the requesting user activating the link also is in possession of the particular user identifier token, which previously was delivered to the requested user in case he was authenticated to access the protected information. If a requesting user who is not in possession of the particular user identifier token (i.e. a requesting user not being authorized to access this specific protected information) activates the link, access will be denied.

Further features of, and advantages with, the present invention will become apparent when studying the appended claims and the following description. Those skilled in the art realize that different features of the present invention can be combined to create embodiments other than those described in the following.

### BRIEF DESCRIPTION OF THE DRAWINGS

A detailed description of preferred embodiments of the present invention will be given with reference made to the accompanying drawing, in which:

FIG. 1 illustrates a method and device of the pre-sent invention.

### DETAILED DESCRIPTION OF PREFERRED EMBODIMENTS OF THE INVENTION

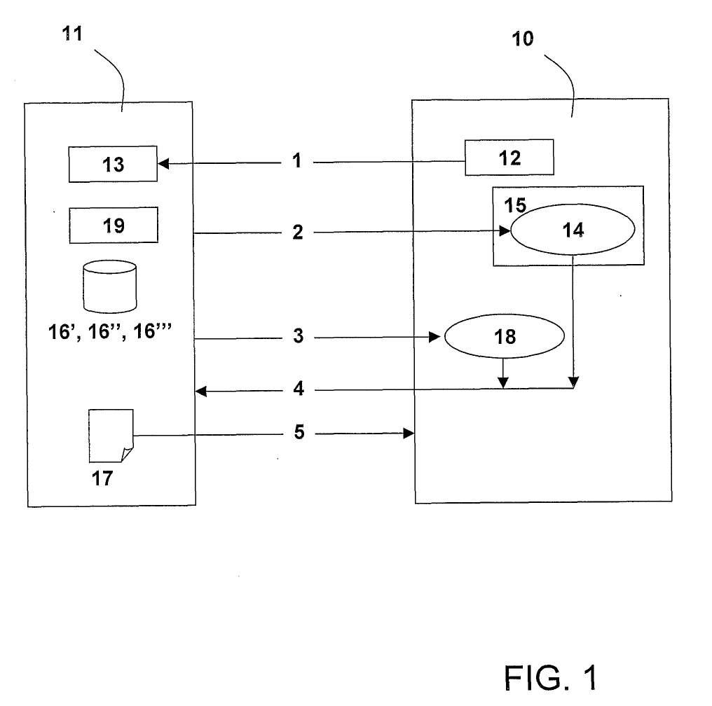

FIG. 1 illustrates how a user 10 communicates with an information provider 11 in a preferred embodiment of the present invention. The user has via a logon mechanism 12 access to an Internet application 13. After using the logon mechanism 12 for authentication (step 1), a user identifier token 14 is created and stored (step 2) at an Internet client storage 15 of the user. An association 16′ between the authenticated user and the user identifier token is created at the provider side.

When protected information 17 is to be made available to the authenticated user 10, the information provider 11 creates an information identifier token 18. The provider also creates an association 16″ between the authenticated user 10 and the protected information 17, and an association 16′″ between the protected information and the information identifier token 18. The information provider 11 then delivers (step 3) the information identifier token 18 to the user via e-mail.

Then, the information provider 11 receives (step 4) a request from a requesting user, which may or may not be the previously mentioned authenticated user 10, to access the protected information 17. The company then verifies that the request comprises a user identifier token and a document identifier token, that the user identifier token of the request is associated 16′ with the previously authenticated user 10, that the information identifier token of the request is associated 16′″ with the requested information, and that the requested information is associated 16″ with the previously authenticated user. If so, there is enough evidence to regard the requesting user to be the previously authenticated user 10, and the requesting user hence gains (step 5) access to the protected information 17.

Note that the steps defined in the method of the present invention is typically performed by a computer 19 at the information provider 11, which computer executes appropriate software for performing these steps. The information provider 11 is typically remotely located from the user 10, which implies that a network, e.g. the Internet, is used to connect the provider 11 and the user 12.

An example of the environment in which the present invention may be applied is given in the following.

Consider a company 11 that has an Internet application 13 for its customers (i.e. users 10). The users logon to the Internet application by stating username and password. They can sign up for receiving invoices, order confirmations and other types of documents electronically. The company also has knowledge about the e-mail addresses of their customers. In this situation, the provided method can be embodied as follows.

When a user 10 signs up for receiving electronic documents, the user is first authenticated (step 1) by means of the username and password. A user identifier token in the form of a cookie 14, is then stored (step 2) on the users' computer 15. The customer is required to allow cookie storage at this stage.

The company 11 stores information about which cookie is stored with which user. This is typically done through using a relational database. Hence, an association 16′ is made between the cookie 14 and the authenticated user 10.

When specific protected information 17 has emerged at the company, which information the user should be allowed to access, e.g. when the company wants to send a document such as an invoice or an order confirmation to a customer, the company stores the information 17 in a database. The company then sends (step 3) an e-mail to the customer 10, with an embedded electronic link to the document (URL). The link comprises an information identifier token in the form of a document code 18 as a parameter. The code is constructed in such a way that it is not possible to derive its content merely from knowledge about the customer 10, the document 17 or the company 11.

The company stores information about which specific document 17 should be available to which user 10, i.e. association 16″ is created and stored. The company also stores information about which document code 18 is associated with which specific document 17, i.e. association 16′″ is created and stored. This is typically done through the use of a relational database.

When the customer receives the e-mail, the customer can use the link in the e-mail to view the document. The web browser of the client computer thus makes a request (step 4) to the company 11.

It is then verified that the request comprises both a document code 18 and a cookie 14. It is also verified that the document code is associated 16′″ with the requested document and that the cookie is associated 16′ with the user to which the document should be available, which availability is determined by association 16″. If so, the requesting user gains access to the protected document.

If the request is not found to comply with the above mentioned verification rules, the user is requested to logon to the Internet application and asked if a cookie should be stored on the computer the user is currently using, to enable future access of documents from this computer.

Note that the steps of enabling a user of an Internet application access to protected information in accordance with the present invention need not be performed in the order given in the method defined by the claims. The information identifier token may, for instance, be created before the user identifier token.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A method of enabling a user of an Internet application access to protected information, said method comprising:
creating user identifier token after authentication of the user by way of a logon mechanism of the Internet application;
associating said user identifier token with the authenticated user;
storing said user identifier token at an Internet client of the authenticated user, the user identifier token not giving access to the Internet application;
associating the protected information with the authenticated user;
creating an information identifier token, the information identifier token not giving access to said Internet application, neither by itself nor in combination with the user identifier token;
associating the information identifier token with the protected information;
delivering the information identifier token to the authenticated user via e-mail;
receiving a request from a requesting user to access the protected information; and
verifying that the request comprises a user identifier token and an information identifier token, and that the user identifier token of the request is associated with the authenticated user, that the authenticated user is associated with the requested protected information and that the requested protected information is associated with the information identifier token of the request, allowing the requesting user to access said protected information.

2. The method according to claim 1, further comprising: providing the protected information with a digital signature.

3. The method according to claim 1, further comprising: creating a hash value for the protected information and giving a requesting user access to the hash value on successful verification.

4. The method according to claim 1, further comprising: encrypting the hash value to provide confidentiality.

5. The method according to claim 1, further comprising: establishing a secure channel for delivery of the protected information.

6. The method according to claim 1, wherein the information identifier token is delivered through a mail with a web link to the protected information.

7. The method according to claim 6, wherein the information identifier token is a code comprised in the web link.

8. The method according to claim 1, wherein said request to access protected information is received over the Internet.

9. The method according to claim 6, wherein the request to access the protected information is made by using the link at the client.

10. The method according to claim 1, wherein the user identifier token is a cookie.

11. The method according to claim 1, wherein the association between the authenticated user and the user identifier token is made effective by an association between a user identifier and a code comprised in the user identifier token.

12. The method according to claim 1, wherein the association between the authenticated user and the protected information is made effective by an association between a user identifier and an identification of an electronic document.

13. The method according to claim 1, wherein the association between the protected information and the information identifier token is made effective by an association between an identification of an electronic document and a code comprised in the information identifier token.

14. The method according to claim 1, wherein said associations are created by using a database.

15. The method according to claim 1, wherein the user identifier token is arranged such that its content cannot be derived from knowledge about at least one of a provider of the protected information and the authenticated user.

16. The method according to claim 13, wherein the information identifier token is arranged such a that its content cannot be derived from knowledge about at least one of a provider of the protected information, the authenticated user and the electronic document.

17. The method according to claim 1, further comprising: receiving, from a user of the Internet application, a request to receive documents electronically, whereupon the protected information is sent to an authenticated user electronically.

18. The method according to claim 1, wherein the creating of the user identifier token is performed during a session when the authenticated user is logged on to the Internet application, and wherein the user identifier token is delivered to the client via the Internet.

19. The method according to claim 1, wherein said Internet application is arranged such that the logon mechanism gives the user authorization to use a set of functions during a session with the Internet application.

20. The method according to claim 1 wherein the verification of the request from a requesting user further comprise: requesting the user to logon to the Internet applications, if the request is found not to comprise a user identifier token, but it is verified that the requested protected information is associated with the information identifier token; and creating a user identifier token and storing the token at the Internet client the user is currently using if the Internet application user after logon is verified to be associated with said requested protected information, the user identifier token not giving access to the Internet application, neither by itself nor in combination with said information identifier token.

21. A device for enabling a user of an Internet application to access protected information, said device comprising:
means for creating a user identifier token after having authenticated the user by a logon mechanism of the Internet application;
means for associating the user identifier token with the authenticated user;
means for delivering the user identifier token to an Internet client of the authenticated user, the user identifier token not giving access to the Internet application;
means for associating the protected information with the authenticated user;
means for creating an information identifier token, the information identifier token not giving access to said Internet application, neither by itself nor in combination with the user identifier token;
means for associating the information identifier token with the protected information;
means for delivering the information identifier token to the authenticated user via e-mail;
means for receiving a request from a requesting user to access the protected information; and
means for verifying that the request comprises a user identifier token and an information identifier token, and that the user identifier token of the request is associated with the authenticated user, that the authenticated user is associated with the requested protected information and that the requested protected information is associated with
the information identifier token of the request, allowing the requesting user to access the protected information.

22. The device according to claim 21, further comprising: means for providing the protected information with a digital signature.

23. The device according to claim 21, further comprising: means for creating a hash value for the protected information and giving a requesting user access to the hash value on successful verification.

24. The device according to claim 21, further comprising: means for encrypting the hash value to provide confidentiality.

25. The device according to claim 21, further comprising: means for establishing a secure channel for delivery of the protected information.

26. The device according to claim 21, wherein the means for delivering the information identifier token is arranged to delivered it via a mail with a web link to the protected information.

27. The device according to claim 26, wherein the information identifier token is a code comprised in the web link.

28. The device according to claim 21, wherein the means for receiving a request is arranged to receive said request to access protected information over the Internet.

29. The device according to claim 27, wherein the link is arranged such that the request to access said protected information is made by using the link at the client.

30. The device according to claim 21, wherein the user identifier token is a cookie.

31. The device according to claim 21, wherein the association between the authenticated user and the user identifier token is arranged such that it is made effective by an association between a user identifier and a code comprised in the user identifier token.

32. The device according to claim 21, wherein the association between the authenticated user and the protected information is arranged such that it is made effective made effective by an association between a user identifier and an identification of an electronic document.

33. The device according to claim 21, wherein the association between the protected information and the information identifier tokens is arranged such that it is made effective by an association between an identification of an electronic document and a code comprised in the information identifier token.

34. The device according to claim 21, wherein the associations are arranged to be created by using a database.

35. The device according to claim 21, wherein the user identifier token is arranged such that its content cannot be derived from knowledge about at least one of a provider of the protected information and the authenticated users.

36. The device according to claim 33, wherein the information identifier token is arranged such that its content cannot be derived from knowledge about at least one of a provider of the protected information, the authenticated user and the electronic document.

37. The device according to claim 21, further comprising: means for receiving, from a user of the Internet application, a request to receive documents electronically, whereupon the protected information is sent to an authenticated user electronically.

38. The device according to claim 21, wherein the means for creating the user identifier token is arranged to create the user identifier token during a session when the authenticated user is logged on to the Internet application, and further arranged to deliver the user identifier token to the client via the Internet.

39. The device according to claim 21, wherein said the Internet application is arranged such that the logon mechanism gives the user authorization to use a set of functions during a session with the Internet application.

40. The device according to claim 21, wherein the means for verifying the request from a requesting user further is arranged:
to request the user to logon to the Internet application, if the request is found not to comprise a user identifier token, but it is verified that the requested protected information is associated with the information identifier token; and
to create a user identifier token and storing the token at the Internet client the user is currently using if the Internet application user after logon is verified to be associated with the requested protected information, the user identifier token not giving access to the Internet application, neither by itself nor in combination with the information identifier token.

41. A computer program product comprising computer executable components for causing a device to perform the method of claim 1 when the computer-executable components are run on a processing unit included in the device.
